(19) United States
(12) Patent Application Publication
(10) Pub. No.: US 2022/0183475 A1
(43) Pub. Date: Jun. 16, 2022

(54) INTEGRATED USER SUPPORT SYSTEM

(71) Applicant: DABIR SURFACES, INC., Chicago, IL (US)

(72) Inventor: David A. DZIOBA, Bellevue, MI (US)

(21) Appl. No.: 17/550,860

(22) Filed: Dec. 14, 2021

Related U.S. Application Data
(60) Provisional application No. 63/125,519, filed on Dec. 15, 2020.

(51) Int. Cl. A47C 27/08; A47C 27/18

(52) U.S. Cl. CPC A47C 27/081; A47C 27/18

(57) ABSTRACT

An integrated user support system includes a point pressure support surface overlay disposed upon and integrated with an underlying support surface. The support surface overlay may permanently or removably enclose the support surface and/or be permanently or removably attached to the support surface.

### CROSS-REFERENCE TO RELATED APPLICATIONS

This application claims the benefit of priority under 35 U.S.C. § 119(e) to U.S. Provisional Patent Application No. 63/125,519, filed Dec. 15, 2020. The disclosure set forth in the referenced application is incorporated herein by reference in its entirety.

### BACKGROUND AND SUMMARY OF THE DISCLOSURE

Operating room (OR) table pads for supporting patients on an operating table during surgical procedures are known in the art. One objective for an OR table pad is to provide a stable support surface upon which the patient may remain substantially motionless during a surgical procedure. Another objective for an OR table pad is to provide a support surface that exerts pressure against the patient in a manner that mitigates the formation of decubitus ulcers (sometimes referred to as pressure ulcers) while the patient remains substantially motionless thereon for the duration of the surgical procedure. A further objective for an OR table pad is to provide a support surface that may be readily cleaned and disinfected so that the OR table pad may be used subsequently by another patient during another surgical procedure.

Known OR table pads often are embodied as one or more layers of dense, closed cell foam or similar materials. Such OR table pads may provide a stable support surface that is readily cleanable. Such OR table pads may be configured to redistribute loads exerted thereby against a patient lying thereon in an attempt to maintain contact pressure against the patient's skin at a pressure value lower than the vascular occlusion threshold (commonly regarded as about 0.5 psi). (Support surfaces that redistribute loads in such a manner sometimes are referred to as pressure redistribution surfaces.) Such OR table pads, however, may have limited efficacy in mitigating the formation of decubitus ulcers because they typically have limited ability to maintain contact pressures lower than the vascular occlusion threshold at all points of contact with the patient.

Some support surfaces attempt to mitigate this problem by providing a plurality of inflatable compartments that may be alternatingly inflated and deflated. The theory behind such support surfaces is that they alternatingly apply pressure to, and relieve pressure from, contact points with the patient's skin to mitigate the formation of decubitus ulcers. Such alternatingly inflatable pressure support surfaces, however, typically operate at inflation pressures of about the vascular occlusion threshold. As such, they typically have the effect of simply redistributing pressure applied by the support surface to the patient's skin. Accordingly, their ability to mitigate decubitus ulcers is limited. Also, many such alternatingly inflatable support surfaces involve substantial and periodic displacement of a user lying thereon as the inflatable compartments are alternatingly inflated and deflated. As suggested above, substantial displacement of a patient during a surgical procedure generally is deemed unacceptable. As such, typical alternatingly inflatable support surfaces are not suitable for use during surgical procedures.

A support surface overlay as disclosed in U.S. Pat. No. 9,216,122 (the disclosure of which is incorporated herein by reference in its entirety) includes alternatingly inflatable compartments defining contact nodes that may be configured to alternatingly apply pressure to and relieve pressure from a patient's skin in a manner that without substantial movement. Such a support surface overlay may be configured with alternatingly inflatable compartments that are selectively inflated to relatively high inflation pressures well above the vascular occlusion threshold, and that do not involve substantial displacement of a patient thereon as the alternatingly inflatable compartments are inflated and deflated. Such a support surface may effectively reduce pressure exerted against the user by the non-inflated compartment to a pressure lower than the vascular occlusion threshold. Such a support surface overlay sometimes is referred to as a point pressure surface overlay.

It may be advantageous in some circumstances to use such a point pressure support surface overlay in combination with an underlying redistribution support surface. Indeed, such point pressure support surface overlays sometimes are used atop a conventional OR table pad during surgical procedures.

One concern with using a point pressure support surface overlay atop a conventional OR table pad is that the support characteristics of a particular point pressure support surface overlay and a particular underlying OR table pad might not be particularly compatible. In other words, some point pressure support surface overlays might be more effective when used with certain underlying support surfaces than with others, and vice versa. As such, random combinations of point pressure support surface overlays and underlying OR table pads might yield support systems that do not mitigate formation of decubitus ulcers as well as others.

The present disclosure describes examples of an integrated user support system including a point pressure support surface overlay integrated with an underlying pressure redistribution surface.

### BRIEF DESCRIPTION OF THE DRAWINGS

FIG. 1 is a exploded schematic perspective view of a support surface overlay disposed upon an underlying support surface.

FIG. 2 is a schematic perspective view of the support surface overlay and underlying support surface of FIG. 1.

FIG. 3 is a schematic side elevation view of the support surface overlay and underlying support surface of FIG. 1.

FIG. 4 is a schematic perspective view of an illustrative embodiment of a support system including a support surface overlay integrated with an underlying support surface according to the present disclosure.

FIG. 5 is a schematic side elevation view of the support system of FIG. 4.

FIG. 6 is a cross-sectional side elevation view of the support system of FIG. 4.

FIG. 7 is a cross-sectional side elevation view of a variation of the support system of FIG. 4.

FIG. 8 is a schematic side view of another illustrative embodiment of a support system including a support surface overlay integrated with an underlying support surface according to the present disclosure.

FIG. 9 is a cross-sectional side elevation view of the support system of FIG. 8.

FIG. 10 is a cross-sectional side elevation view of a variation of the support system of FIG. 8.

FIG. 11 is a schematic perspective view of a further illustrative embodiment of a support system including a support surface overlay integrated with an underlying support surface according to the present disclosure.

FIG. 12 a schematic side elevation view of the support system of FIG. 11.

FIG. 13 is a cross-sectional side elevation view of the support system of FIG. 11.

FIG. 14 is a plan view of an illustrative selectively inflatable bladder of a support surface overlay for use in the system of the present disclosure.

FIG. 15 is a plan view of an illustrative support surface overlay for use in the system of the present disclosure.

FIG. 16 is a side cross-sectional view of the support surface overlay of FIG. 11.

FIG. 17 is another side cross-sectional view of the support surface overlay of FIG. 11 showing the selectively inflatable bladder in a deflated state.

FIG. 18 is another side cross-sectional view of the support surface overlay of FIG. 11 showing the selectively inflatable bladder in an inflated state.

### DETAILED DESCRIPTION OF THE DRAWINGS

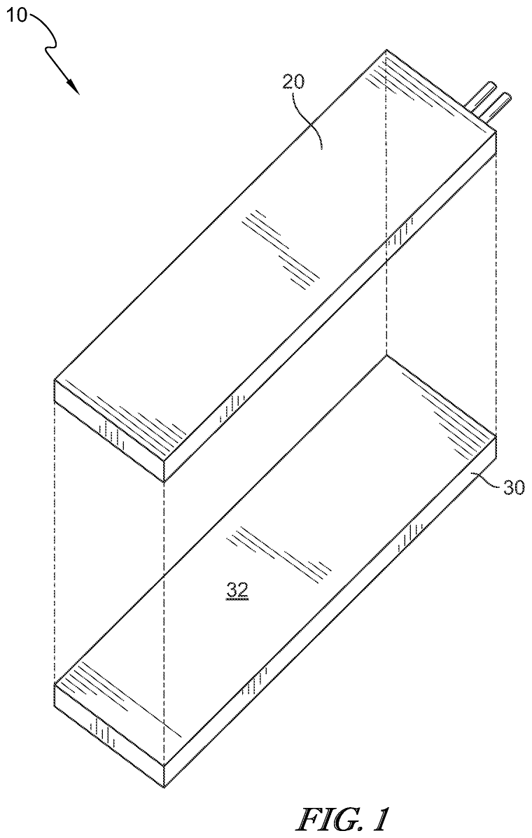

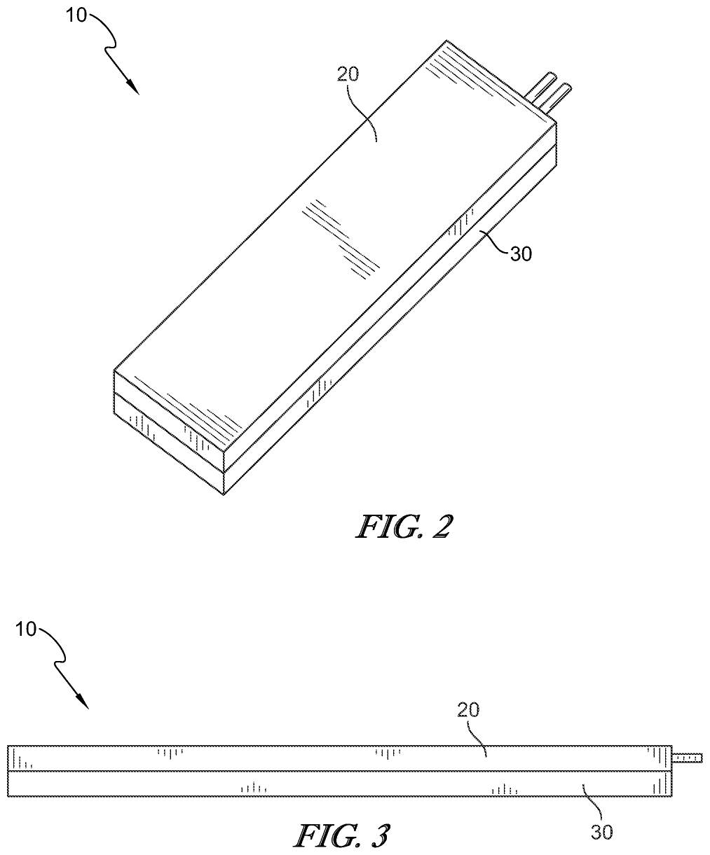

FIGS. 1-3 show schematically a support system 10 including a support surface overlay 20 disposed upon an underlying support surface 30. More specifically, the support surface overlay 20 is disposed upon an upper face 32 of the underlying support surface 30. The support surface overlay 20 and the support surface 30 are discrete elements. Because the support surface overlay 20 and the support surface 30 are discrete elements, a user may readily combine a particular support surface overlay 20 and a particular support surface 30 without regard to compatibility of the functional and operating characteristics of the particular support surface overlay 20 with respect to the functional and operating characteristics of the particular support surface 30. Also, because the support surface overlay 20 and the support surface 30 are discrete elements, they may be free to move with respect to each other during use, thereby potentially denigrating the overall support characteristic thereof.

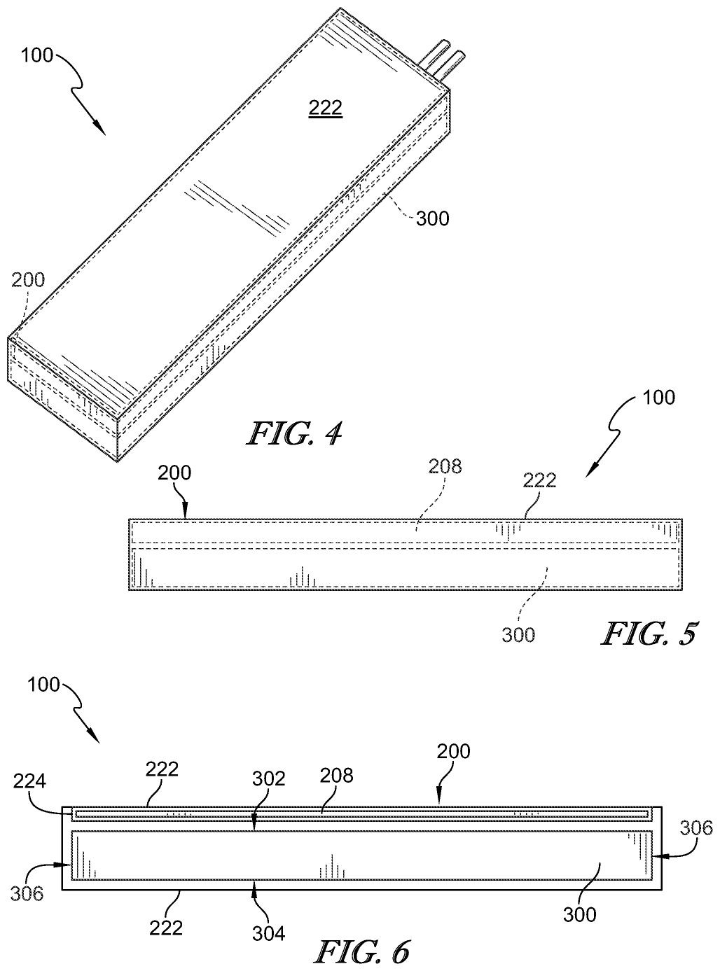

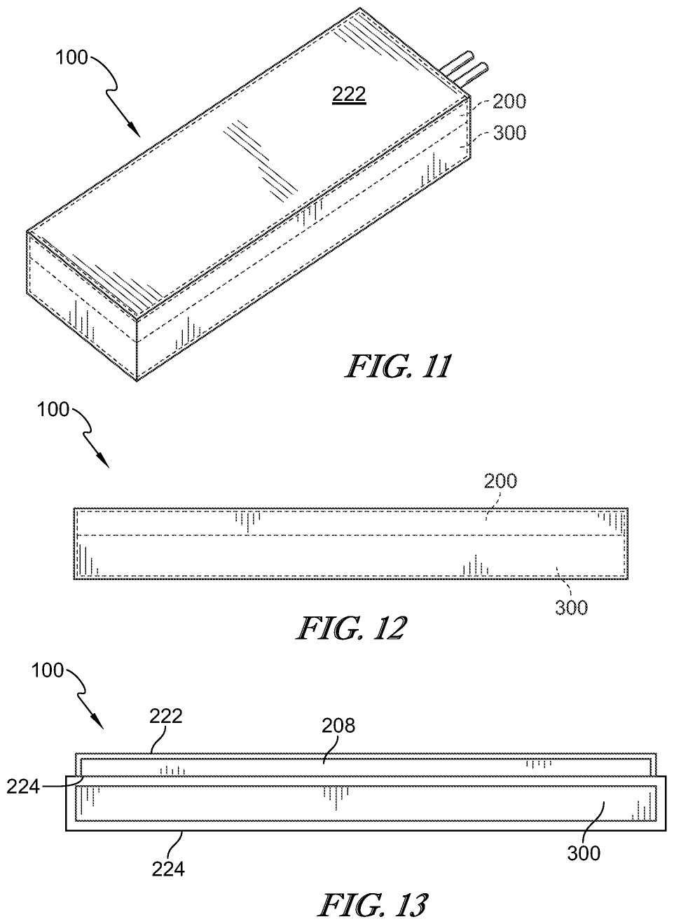

FIGS. 4-13 show illustrative embodiments of an integrated support system 100 including a discrete support surface overlay 200 and a discrete underlying support surface 300, wherein: (i) the support surface overlay 200 encloses the support surface 300; (ii) the support surface overlay 200 is attached to the support surface 300; or (iii) the support surface overlay 200 both encloses and is attached to the support surface 300.

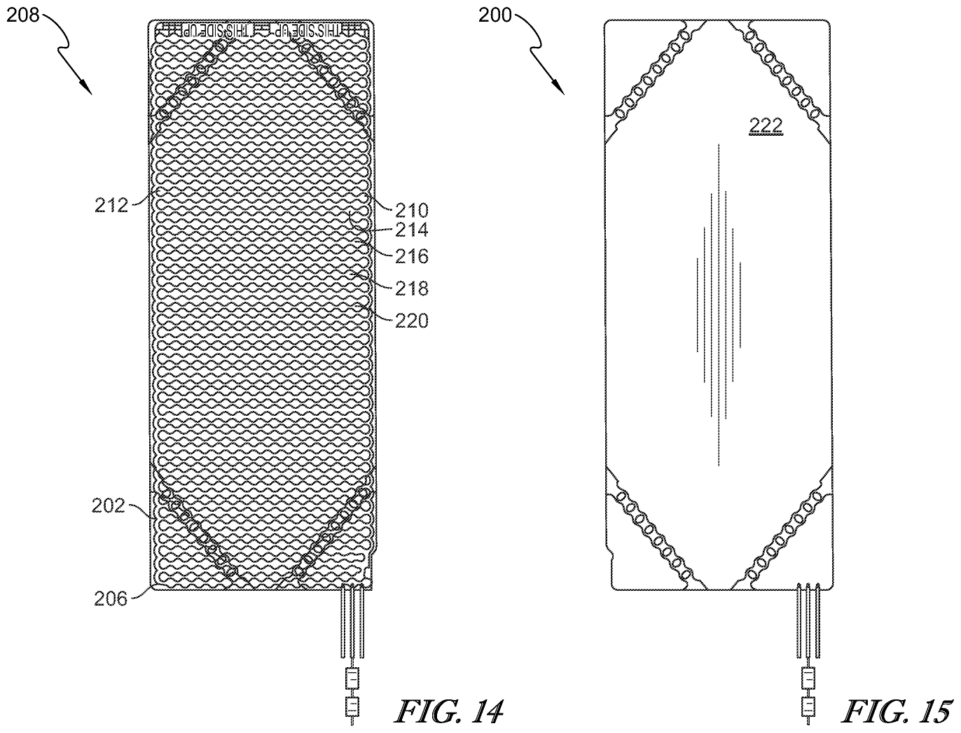

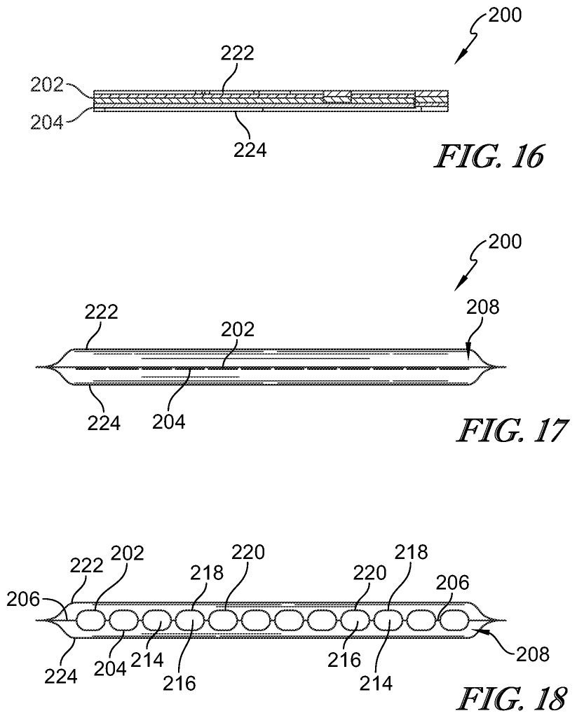

FIGS. 14-18 show in further detail illustrative embodiments of a support surface overlay 200 for use in the support system 100.

For clarity, the drawings may show a gap between the support surface overlay 200 and the support surface 300. In practice, the support surface overlay 200 typically would be in contact with the support surface 300. Such contact may be direct or through an intervening layer of additional material (not shown). The support surface 300 may be embodied as an OR table pad, a bed mattress, a seat cushion, or any other structure that provides support to a user.

As best shown in FIGS. 14-18, the support surface overlay 200 includes a first (or upper) sheet 202 and a second (or lower) sheet 204 bonded to the upper sheet 202 along one or more seams 206. As best shown in FIGS. 14, 17, and 18, the upper sheet 202, the lower sheet 204, and the seam 206 cooperate to define a bladder 208 including first and second selectively inflatable compartments 210, 212. Each selectively inflatable compartment 210, 212 defines a corresponding plurality of selectively inflatable cells 214, 216. When inflated, the cells 214, 216 define corresponding contact nodes 218, 220 configured to selectively impart point pressure against a user disposed upon the support surface overlay 200.

In other embodiments, the upper sheet 202, the lower sheet 204, and the seam 206 may cooperate to define more or fewer than two selectively inflatable compartments, each such selectively inflatable compartment defining corresponding selectively inflatable cells, and each such selectively inflatable cell defining a corresponding contact node.

The support surface overlay 200 also includes a first (or upper) cover sheet 222 overlying the upper sheet 202 of the bladder 208. The bladder 208 and the upper cover sheet 222 may be bonded together along at least portions thereof proximate the periphery of the bladder 208.

In embodiments, the support surface overlay 200 may also include a second (or lower) cover sheet 224 underlying the lower sheet 204 of the bladder 208. In such embodiments, the bladder 208, the upper cover sheet 222, and the lower cover sheet 224 may be bonded together along at least portions thereof proximate the periphery of the bladder 208.

In embodiments including the upper cover sheet 222 and the lower cover sheet 224, the upper cover sheet 222 and the lower cover sheet 224 may sometimes be referred to collectively as an envelope that encloses the bladder 208.

In embodiments, as will be discussed further below, either or both of the upper cover sheet 222 and the lower cover sheet 224 may be configured to: (a) permanently or removably encompass the support surface 300; (b) be permanently or removably attached to the support surface 300; or (c) permanently or removably encompass the support surface 300 and be permanently or removably attached to the support surface 300.

FIGS. 4, 5, and 8 show schematically illustrative embodiments wherein a support surface overlay 200 having both an upper cover sheet 222 and a lower cover sheet 224 is disposed upon an upper face 302 of the support surface 300 and wherein the support surface overlay 200 is integrated with the support surface 300. FIGS. 6, 7, 9, and 10 show such illustrative embodiments in greater detail.

FIG. 6 shows an illustrative embodiment wherein the support surface overlay 200 is disposed upon the support surface 300, and wherein the upper cover sheet 222 extends beyond the bladder 208, about the support surface 300, and completely encloses the support surface 300.

That is, the upper cover sheet 222 extends about and encloses the upper face 302, a lower face 304, and side faces 306 of the support surface 300. In some embodiments, the upper cover sheet 222 may enclose less than the entirety of the support surface 300. For example, the upper cover sheet 222 may enclose the entirety of the upper face 302 and the side faces 306 of the support surface 300, but less than the entirety of the lower face 304 of the support surface 300.

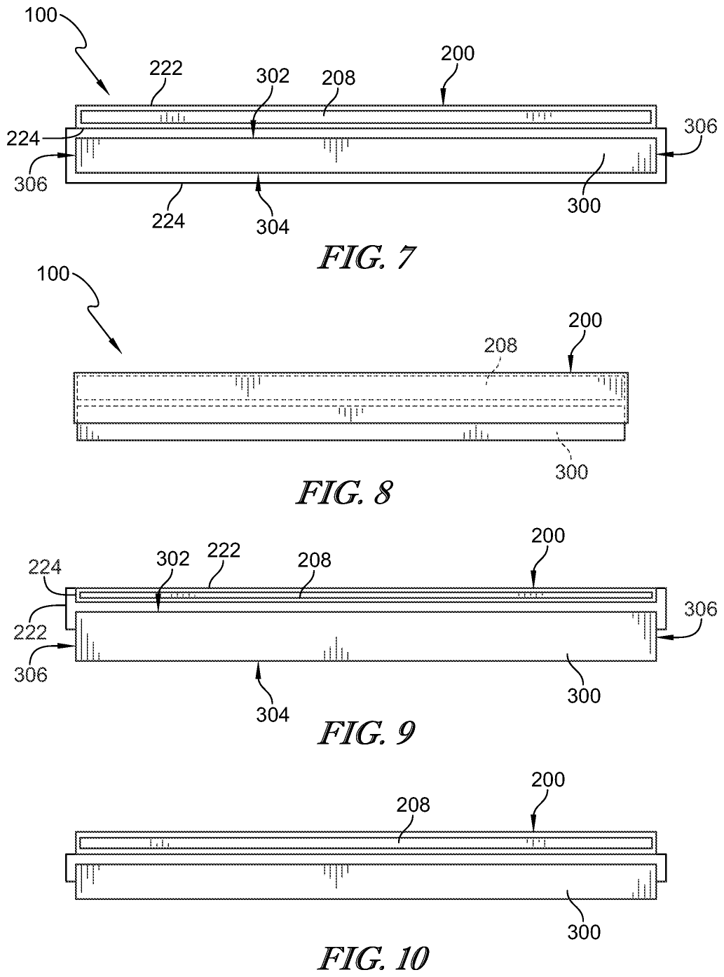

FIG. 7 shows an illustrative embodiment wherein the support surface overlay 200 is disposed upon the support surface 300, and wherein the lower cover sheet 224 extends beyond the bladder 208, about the support surface 300, and completely encloses the support surface 300. That is, the lower cover sheet 224 extends about and encloses the upper face 302, a lower face 304, and side faces 306 of the support surface 300. In some embodiments, the lower cover sheet 224 may enclose less than the entirety of the support surface 300. For example, the lower cover sheet 224 may enclose the entirety of the upper face 302 and the side faces 306 of the support surface 300, but less than the entirety of the lower face 304 of the support surface 300.

In embodiments wherein the upper or lower cover sheet 222, 224 completely encloses the support surface 300, such enclosure may be permanent. In embodiments, the upper or lower cover sheet 222, 224 may hermetically enclose the support surface 300. Alternatively, such enclosure may be removable. For example, the upper or lower cover sheet 222, 224 may define an opening through which the support surface 300 may be inserted or removed. Such opening may be closable by any suitable means, for example without limitation, a zipper, buttons, hook-and-loop fasteners, and a labyrinth arrangement.

FIG. 9 shows an embodiment wherein the upper cover sheet 222 extends beyond the bladder 208 and along the side faces 306 of the support surface 300, and wherein the upper cover sheet 222 is permanently or removably attached to the side faces 306 of the support surface 300. Such attachment may be by any suitable means, including without limitation, sewing, a zipper, buttons, and hook-and-loop fasteners. In embodiments, the upper cover sheet 222 could further extend about a portion of the bottom face 304 of the support surface 300 and could instead or additionally be permanently or removably attached to the bottom face 304.

FIG. 10 shows an embodiment wherein the lower cover sheet 224 extends beyond the bladder 208 and along the side faces 306 of the support surface 300, and wherein the lower cover sheet 224 is permanently or removably attached to the side faces 306 of the support surface 300. Such attachment may be by any suitable means, including without limitation, sewing, a zipper, buttons, and hook-and-loop fasteners. In embodiments, the lower cover sheet 224 could further extend about a portion of the bottom face 304 of the support surface 300 and could instead or additionally be permanently or removably attached to the bottom face 304.

As shown in FIGS. 11-13, the lower cover sheet 224 may be omitted, and the upper cover sheet 222 may be configured to enclose the support surface 300 as discussed above. In such embodiments, the lower sheet 204 of the bladder 208 may abut the support surface 300, either directly or through an intervening layer of additional material. Alternatively, the lower cover sheet 224 may be omitted, and the upper cover sheet 222 may partially enclose and be attached to the support surface 300 as discussed above. In such embodiments, the lower sheet 204 of the bladder 208 may directly abut the support surface 300, either directly or through an intervening layer of additional material.

In embodiments wherein the lower cover sheet 224 is omitted, the upper face 302 of the support surface 300 may be selected to provide a suitable reaction force to resist deformation in response to pressure imparted thereto by the support surface overlay 200 when the bladder 208 thereof is inflated and a user is disposed thereon, so that the upper face 302 of the support surface 300 does not closely conform to the lower sheet 204 of the bladder 208. For example, the upper face 302 of the support surface 300 may be made of a material, for example, a material typically used in the construction of parachutes, that resists elastic stretching when subjected to a load perpendicular thereto as would occur when the bladder 208 of the support surface overlay 200 thereon is inflated with a user disposed thereon so that the upper face 302 of the support surface 300 does not closely conform to the lower sheet 204 of the bladder 208.

Terms of orientation, for example, upper, lower, top, bottom, and the like, as used herein should be construed in a relative and not absolute sense unless context clearly dictates otherwise.

The embodiments shown and described herein are illustrative and should not be construed to limit the scope of the invention as may be claimed herein or in any related application.

1. A support system comprising:
a support surface overlay configured to support a user disposed thereon; and
a support surface underlying the first support surface overlay, the support surface configured to support the support surface overlay and the user disposed thereon;
wherein the support surface overlay comprises:
a selectively inflatable bladder comprising:
a first sheet of flexible material; and
a second sheet of flexible material bonded to the first flexible material to define a first selectively inflatable compartment, the first selectively inflatable compartment defining a plurality of contact nodes when inflated; and
an envelope bonded to and enclosing the selectively inflatable bladder, the envelope comprising:
a lower sheet underlying the selectively inflatable bladder and
an upper sheet overlying the selectively inflatable bladder,
wherein the support surface overlay: (i) encloses the support surface; (ii) is attached to the support surface; (iii) or both encloses and is attached to the support surface.

2. The support system of claim 1 wherein the upper sheet of the envelope extends about and encases the support surface.

3. The support system of claim 1 wherein the lower sheet of the envelope extends about and encases the support surface.

4. The support system of claim 1 wherein the upper sheet of the envelope is attached to the support surface.

5. The support system of claim 1 wherein the lower sheet of the envelope is attached to the support surface.

6. The support system of claim 1 wherein an upper face of the support surface defines the lower sheet of the envelope.

7. The support system of claim 6 wherein an upper face of the support surface is configured to resist deformation in response to the pressure imparted thereto by the nodes of the support surface overlay.

8. The support system of claim 7 wherein the upper face of the support surface is configured to resist conforming to inflated nodes of the support surface overlay.

9. A support system comprising:
a support surface overlay configured to support a user disposed thereon; and
a support surface underlying the support surface overlay, the support surface configured to support the support surface overlay and the user disposed thereon;
wherein the support surface overlay comprises:
a selectively inflatable bladder comprising:
a first sheet of flexible material; and
a second sheet of flexible material bonded to the first flexible material to define a first selectively inflatable compartment, the first selectively inflatable compartment defining a plurality of contact nodes when inflated; and
an upper cover sheet overlying the selectively inflatable bladder,
wherein the support surface overlay: (i) encloses the support surface; (ii) is attached to the support surface; (iii) or both encloses and is attached to the support surface.

10. The support system of claim 9 wherein the upper cover sheet extends about and encases the support surface.

11. The support system of claim 9 wherein the upper cover sheet is attached to the support surface.

12. The support system of claim 9 wherein an upper face of the support surface is configured to resist deformation in response to the pressure imparted thereto by the nodes of the support surface overlay.

13. The support system of claim 12 wherein the upper face of the support surface is configured to resist conforming to inflated nodes of the support surface overlay.

14. The support system of claim 9 wherein the support surface overlay further comprises a lower cover sheet underlying the selectively inflatable bladder.

15. The support system of claim 14 wherein the lower sheet of the envelope extends about and encases the support surface.

16. The support system of claim 14 wherein the lower sheet of the envelope is attached to the support surface.

17. The support system of claim 14 wherein the lower cover sheet resists conforming to inflated nodes of the support surface overlay.

18. The support system of claim 9, wherein:
the support surface overlay is configured to selectively apply point pressure to the user at ones of a first plurality of support nodes; and
the support surface is configured to redistribute pressure applied thereto by the support surface overlay.

19. The support system of claim 9 wherein the support surface comprises a flexible and resilient material.

20. The support system of claim 9 wherein the support surface comprises a flexible and resilient foam material.
